(19) United States
(12) Patent Application Publication
(10) Pub. No.: US 2002/0153379 A1
(43) Pub. Date: Oct. 24, 2002

(54) Liquor icing vessel

(76) Inventor: Wen-Yuan Liu, Yung-Kang City (TW)

Correspondence Address: Wen-Yuan Liu, P.O. Box 90, Tainan City, 704, TW

(21) Appl. No.: 09/838,332

(22) Filed: Apr. 20, 2001

(51) Int. Cl. A47J 39/00; A47J 41/00; B65D 81/38; B65D 83/72

(52) U.S. Cl. 220/592.16

(57) ABSTRACT

A liquor-icing vessel includes an outer vessel and an inner vessel combined together. The outer vessel has a hollow interior and a narrow opening formed in an upper end, and the inner vessel has a flange around the opening and an annular groove formed between the flange and the wall of the opening for the wall of the opening of the outer vessel to fit therein from under when the inner vessel is deposited in the hollow interior of the outer vessel half filled with ice cubes. Then the liquor bottle with liquor stored inside may be cooled by the inner vessel, which is then cooled by the ice cubes or water molten in the outer vessel. Thus the ice cubes or water does not wet the liquor bottle.

### BACKGROUND OF THE INVENTION

1. Field of the Invention

This invention relates to a liquor icing vessel, particularly to one consisting of an outer vessel and an inner vessel combined together easily and detachably, with the inner vessel separating a liquor bottle from ice cubes stored in the outer vessel, cooling the liquor bottle without wetted by cool ice cubes and molten water.

2. Description of the Prior Art

Common conventional liquor icing vessels are generally shaped as shown in FIG. 1, having a vessel body 1 for storing ice cubes 4 therein, and then a liquor bottle 5 with liquor is forced into the ice cubes 4. Then as the ice cubes 4 may gradually melt to become ice water to cool the liquor bottle 5 because of time, air and room temperature difference. When the liquor bottle 5 is taken out of the icing vessel 1 after cooled by the ice cubes and molten water, it will have some water attached on its outer surface so that the liquor bottle has to be wiped dry, or ice water may drip down from the liquor bottle on the ground or a table. Otherwise, ice water may drip down into a glass when the liquor is inclined to pour out liquor out of the bottle 1, not hygienic.

### SUMMARY OF THE INVENTION

This invention has been devised to offer a liquor icing vessel consisting of an outer vessel and an inner vessel detachably combined easily, with the inner vessel separating a liquor bottle from ice cubes and molten water so that the liquor bottle may be cooled without being wetted by the ice water.

The feature of the invention is an outer vessel having a narrow opening formed in upper end, and an inner vessel deposited in a hollow interior of the outer vessel and, having an opening formed in an upper end and a flange formed around the opening, and an annular groove formed between the flange and the wall of the inner vessel for fitting the annular wall of the opening of the outer vessel.

### BRIEF DESCRIPTION OF DRAWINGS

This invention will be better understood by referring to the accompanying drawings, wherein:

FIG. 1 is a side cross-sectional view of a known conventional liquor-icing vessel in using condition;

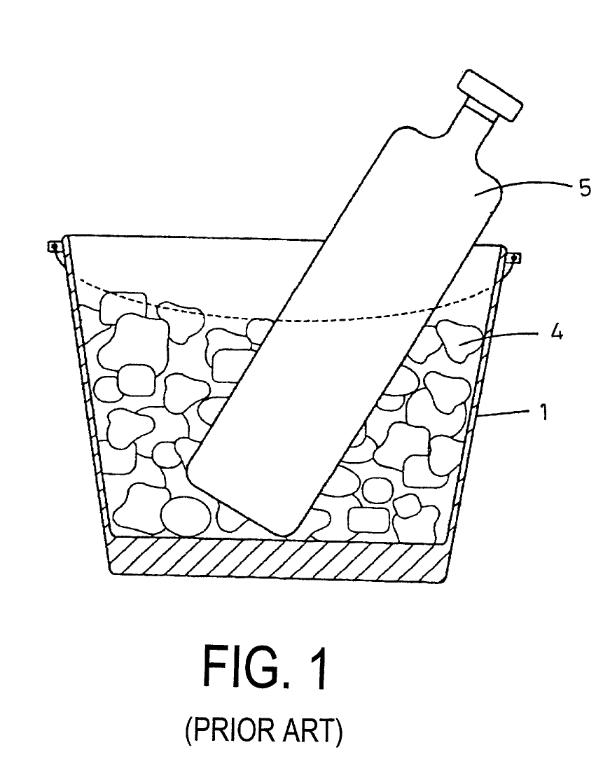

FIG. 2 is an exploded perspective view of a liquor-icing vessel in the present invention;

FIG. 3 is a perspective view of a liquor-icing vessel in the present invention;

FIG. 4 is a side cross-sectional view of the liquor-icing vessel in the present invention; and,

FIG. 5 is a side view of the liquor-icing vessel in using condition in the present invention.

### DETAILED DESCRIPTION OF THE PREFERRED EMBODIMENT

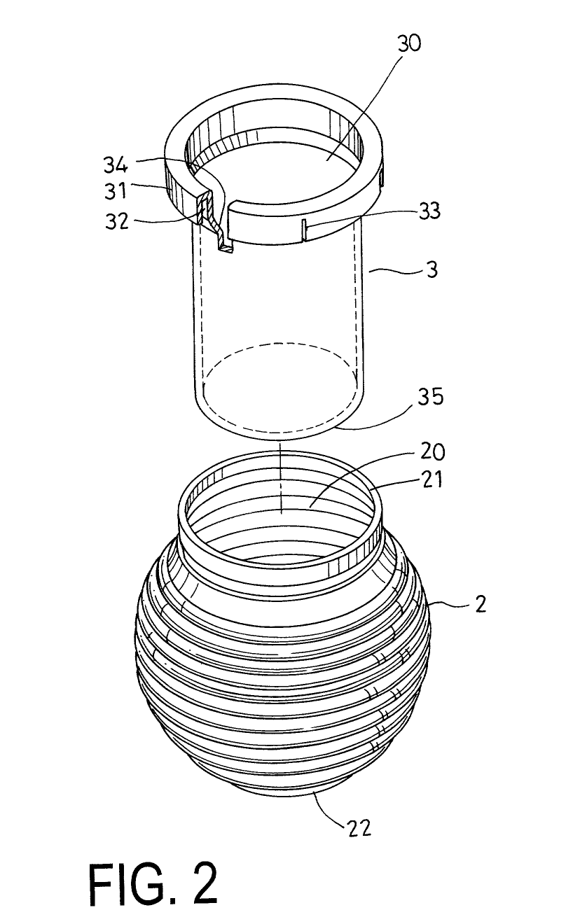

A preferred embodiment of a liquor-icing vessel in the present invention, as shown in FIGS. 2, 3 and 5, includes an outer vessel 2 and an inner vessel 3 as main components combined together.

The outer vessel 2 has a hollow interior 20, a narrow opening 21 formed in an upper end, and a flat bottom 22 for convenience to stand on a flat table surface or the like.

The inner vessel 3 is formed to fit in the hollow interior 20 of the outer vessel 2, having an opening 30 formed in an upper end, a flanges 31 formed on an around the opening 30, and an annular groove 32 is formed between the wall of the opening and the flange 31 to fit tightly with an annular wall of the opening 21 of the outer vessel 2 with the flange provided with plural vertical slots spaced apart to give the flange some resilience to shrink and expand. Further, the inner vessel 3 has an annular-curved surface 34 near under the opening 30, and a flat bottom 35 sitting flatly on the bottom 22 of the outer vessel 2. The outer diameter of the inner vessel body 36 is a bit smaller than the diameter of the opening 21.

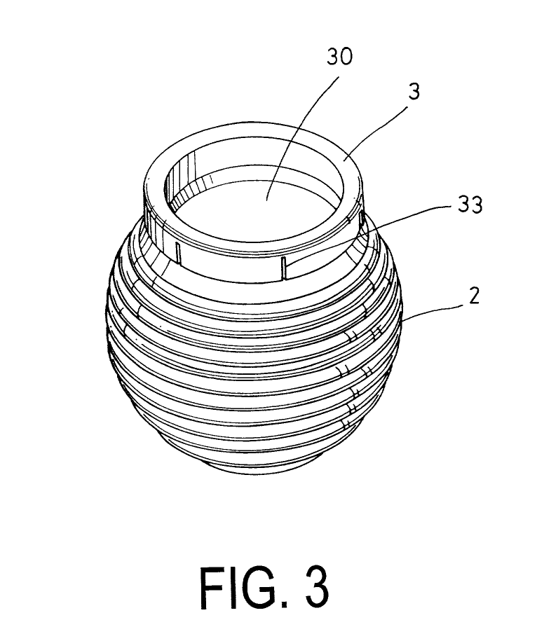

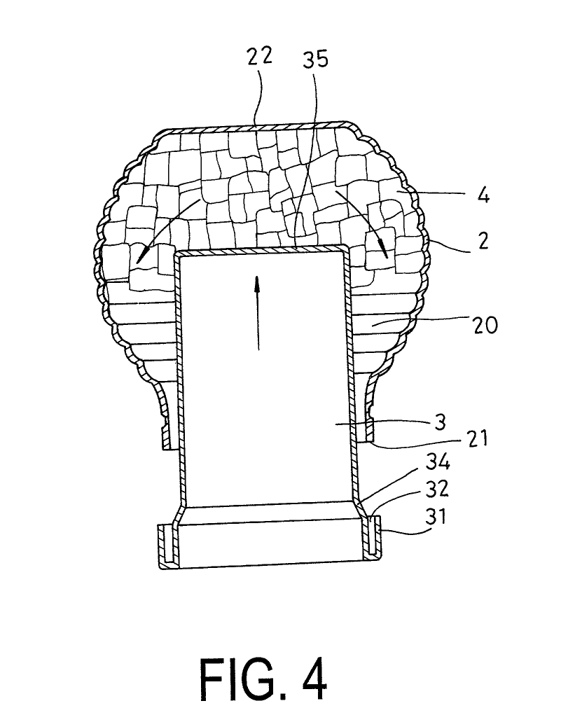

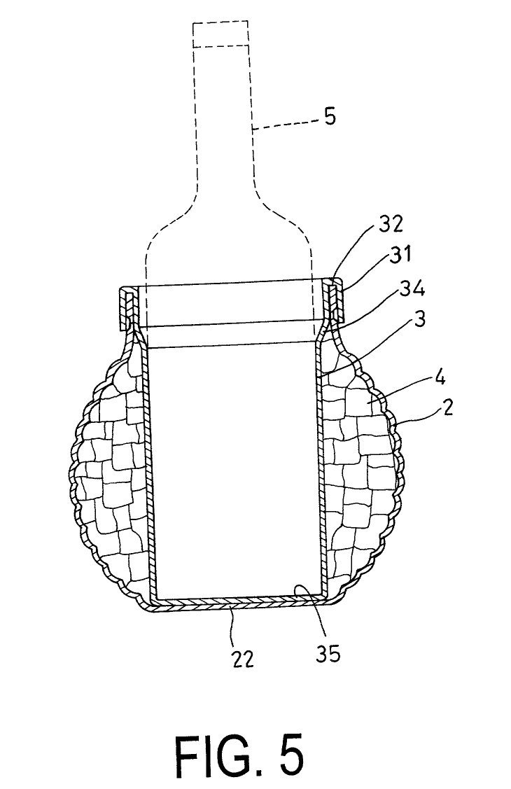

In assembling and using, referring to FIGS. 2-5, firstly, pour ice cubes 4 in half the hollow interior 20 as shown in FIG. 4. Next, insert the inner vessel 3 through the opening 21 of the outer vessel 2 until the bottom 35 of the inner vessel 3 reaches an upper level of the ice cubes 4, and then invert the inner and the outer vessel 3 and 2 together, and shake the outer vessel 2, forcing the ice cubes 4 move to the right and the left repeatedly, letting the inner vessel 3 gradually insert in the ice cubes 4 until the bottom 35 of the inner vessel 3 contacts the bottom 22 of the outer vessel 2, as show in FIG. 5. In addition, the annular wall of the opening 21 of the outer vessel 21 fits in the annular groove 32 of the inner vessel from under, with the annular curved surface 33 slides smoothly through the opening 21 and the plural slots 33 in the flange 31 function to shrink and expand to keep stably the inner vessel 3 with the outer vessel 2, as shown in FIG. 3. Then a liquor bottle 5 is placed through the opening 30 of the inner vessel 3 until the bottom of the liquor bottle sits on the bottom 35 of the inner vessel 3 so that the bottle 5 with liquor stored inside may be cooled by the inner vessel 3, which is then cooled by the ice cubes in the outer vessel 2.

The liquor icing vessel in the invention has the following advantage, as can be understood from the aforesaid description.

1. The inner vessel and the outer vessel can be combined together very simply and stably and detachably.

2. A liquor bottle is separated by the inner vessel from the ice cube or molten water stored in the outer vessel, so the liquor bottle with liquor stored inside may not be wetted by ice water, but still can be cooled effectively.

While the preferred embodiment of the invention has been described above, it will be recognized and understood that various modifications may be made therein and the appended claims are intended to cover all such modifications that may fall into the sprit and scope of the invention.

What is claimed is:

1. A liquor icing vessel comprising an outer vessel and an inner vessel combined together, said outer vessel having an hollow interior and a narrow opening formed in upper end, said inner vessel deposited in said hollow interior of said outer vessel and having an opening formed in an upper end, a flange formed around said opening of said inner vessel, said flange and an annular wall of said opening forming an annular groove, said outer vessel having its hollow interior half filled with ice cubes, said inner vessel placed in said hollow interior stored with ice cubes and pushed into said ice cubes by shaking said outer vessel until the bottom of said inner vessel sits on the bottom of said outer vessel so that said liquor bottle with liquor stored therein may be cooled by said inner vessel, which is them cooled by the ice cubes or molten water stored in said outer vessel, with said liquor bottle not wetted by said molten water in said outer vessel.

2. The liquor icing vessel as claimed in claim 1, wherein said outer vessel has a flat bottom so as to stand stably on a flat table or the like.

3. The liquor icing vessel as claimed in claim 1, wherein said inner vessel has an annular curved surface under said flange to slide smoothly through said opening of said outer vessel to let said annular groove fit with the wall of said opening of said outer vessel, and said flange has a plurality of vertical slots spaced apart so as to let said flange have some elasticity to shrink and expand for combining said inner vessel with said outer vessel easily and stably.
